(19) United States
(12) Patent Application Publication
(10) Pub. No.: US 2021/0110815 A1
(43) Pub. Date: Apr. 15, 2021

(54) METHOD AND APPARATUS FOR DETERMINING SEMANTIC MEANING OF PRONOUN

(71) Applicant: LG ELECTRONICS INC., Seoul (KR)

(72) Inventor: Jichan MAENG, Seoul (KR)

(73) Assignee: LG ELECTRONICS INC., Seoul (KR)

(21) Appl. No.: 16/802,429

(22) Filed: Feb. 26, 2020

(30) Foreign Application Priority Data
Oct. 15, 2019 (KR) 10-2019-0127673

(51) Int. Cl. G10L 15/18; G06F 3/01; G06K 9/00; G10L 15/25; G10L 15/22

(52) U.S. Cl. CPC G10L 15/1815; G06F 3/013; G06K 9/00362; G10L 2015/223; G10L 15/25; G10L 15/22; G06K 9/00624

(57) ABSTRACT

The present disclosure relates to a method and an electronic device for substituting the name of an object for a corresponding pronoun occurring in a speech. The method includes acquiring a speech, generating text data from the speech, generate a pronoun list and first target object assumption information, recognizing objects from the images, recognizing a speaker from among the recognized objects, generate second target object assumption information, determine target objects referred to by the respective pronouns; and determine target object names corresponding to the determined target objects. Since each of the pronouns is replaced with the name of a corresponding one of the target objects, listeners or viewers who later listen to or view a record file can avoid having difficulty in understanding the content of the record file. Therefore, usability and each of use of a recording application or device can be improved.

### CROSS REFERENCE TO RELATED APPLICATION

Pursuant to 35 U.S.C. § 119(a), this application claims the benefit of earlier filing date and right of priority to Korean Patent Application No. 10-2019-0127673, filed Oct. 15, 2019, the contents of which are all hereby incorporated by reference herein in its entirety.

### BACKGROUND

As technology advances, devices with an artificial intelligence (AI) function are being widely introduced. Examples thereof include smart phones or Internet of Things (IoT) devices equipped with a voice agent capable of recognizing and interpreting a voice command and providing a response or an appropriate service by using artificial intelligence.

A speaker in voice recording or speech recognition frequently utters pronouns to refer to specific things or people during speech. However, in the case of a long speech, it is often impossible to know what a pronoun refers to.

### SUMMARY

In the case of acquiring voice data through voice recording or speech recognition, it is often difficult to determine a target object that is referred to by a pronoun depending on the situation. For example, pronouns are frequently used in a conference meeting conducted with visual material. When the conference meeting is recorded and only an audio file of the conference meeting is later played back, it is difficult for listeners to specify objects (things or people) referred to by the pronouns during the playback of the audio file since the meanings of the pronouns must be inferred from the context.

Various embodiments of the present disclosure provide a method of determining a target object referred to by a pronoun included in an utterance (speech) on the basis of the context of the speech and image information of a speaker by using artificial intelligence technology.

In addition, various embodiments of the present disclosure provide a method of and an apparatus for replacing a pronoun included in an utterance (speech) during voice recording with a target object that is inferred to be referred to by the pronoun.

Technical problems to be resolved by the present disclosure are not limited to the technical problems mentioned above, and other technical problems that are not mentioned above and can be resolved by the present disclosure will be clearly understood by those skilled in the art from the following description.

According to various embodiments of the present disclosure, an electronic device may comprises at least one camera configured to capture one or more images, a microphone configured to acquire speech, and at least one processor configured to acquire the speech through the microphone, generate text data from the acquired speech, generate a pronoun list and first target object assumption information from the generated text data, wherein the first target object assumption information includes target objects assumed to be referred to by respective pronouns in the pronoun list based on contextual information from the generated text data, recognize one or more objects from the one or more images captured by the at least one camera, recognize a speaker from among the recognized one or more objects, generate second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition, determine target objects referred to by the respective pronouns, and determine target object names corresponding to the determined target objects based on the generated first target object assumption information and the generated second target object assumption information.

According to various embodiments of the present disclosure, a method may comprises acquiring speech through a microphone, generating text data from the acquired speech, generating a pronoun list and first target object assumption information from the generated text data, wherein the first target object assumption information includes target objects assumed to be referred to by respective pronouns in the pronoun list based on contextual information from the generated text data, recognizing one or more objects from one or more images captured by at least one camera, recognizing a speaker from among the recognized one or more objects, generating second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition, determining target objects referred to by the respective pronouns, and determining target object names corresponding to the determined target objects based on the generated first target object assumption information and the generated second target object assumption information.

According to various embodiments of the present disclosure, by using image information as well as context information to determine an object referred to by a pronoun that occurs in voice data, the accuracy of the determination of objects referred to by pronouns can be improved as compared with a method of determining objects referred to by respective pronoun using only context information.

In addition, according to various embodiments of the present disclosure, by replacing a pronoun with the name of a corresponding target object during voice recording, listeners who later listen to a voice record can easily understand the conversation without confusion which may occur due to the use of pronouns in the conversation. Therefore, convenience and usability of a recording application or device can be improved.

In addition, according to various embodiments of the present disclosure, a target object can be clearly identified by using information on the target object, which is acquired from an “image”, without having to specify the target object with “voice” when a voice command is made. Therefore, a useful user experience can be realized.

Effects that can be acquired by various embodiments of the present disclosure are not limited to the above-mentioned effects, and other effects not mentioned above are also apparent to those skilled in the art from the following description.

### BRIEF DESCRIPTION OF THE DRAWINGS

FIG. 1 is a block diagram illustrating an electronic device for speech recognition or voice recording according to various embodiments of the present disclosure.

FIG. 2 is a diagram illustrating a voice system according to various embodiments of the present disclosure.

FIG. 3 is a diagram illustrating a process of extracting a speech feature of a user from a voice signal according to various embodiments of the present disclosure.

FIG. 4 illustrates an example in which a voice signal is converted into a power spectrum, according to an embodiment of the present disclosure.

FIG. 5 is a block diagram illustrating operations performed by at least one processor of an electronic device according to various embodiments of the present disclosure.

FIG. 6 is a block diagram illustrating operations performed by at least one processor of an electronic device according to various embodiments of the present disclosure and a processor of an additional device that operates in conjunction with the processer of the electronic device to determine a target object referred to by a pronoun.

FIG. 7 is a flowchart illustrating a method in which an electronic device 100 records speech while replacing pronouns included in the speech with names of corresponding objects, respectively.

Through the drawings, the same or similar components may be denoted by the same or similar reference numerals.

### DESCRIPTION OF THE PREFERRED EMBODIMENTS

Hereinafter, embodiments of the present disclosure will be described in detail with reference to the accompanying drawings. In the description, the same or equivalent components may be given the same reference numerals, and description thereof will not be repeated.

In general, a suffix such as “module” and “unit” may be used to refer to elements or components. Use of such a suffix herein is merely intended to facilitate description of the specification, and the suffix itself is not intended to give any special meaning or function. In addition, the term “module” or “unit” refers to a software component or a hardware component such as a field programmable gate array (FPGA) or an application specific integrated circuit (ASIC), and the modules or units perform certain roles. However, the meaning of the term “module” or “unit” is not limited to software or hardware. The “module” or “unit” may be configured to reside in an addressable storage medium or may be configured to operate one or more processors. Thus, as an example, a module or a unit may include components such as software components, object-oriented software components, class components, and task components, processes, functions, properties, procedures, subroutines, segments of program code, drivers, firmware, microcode, circuitry, data, databases, data structures, tables, arrays, and variables. Functions provided by components, modules, or units may be combined into a smaller number of components, module, or units or may be further divided into a larger number of components, modules, or units.

The operations of a method or algorithm described in connection with some embodiments of the present disclosure may be embodied in hardware, software, or a combination of both. The software module may reside in a RAM memory, flash memory, ROM memory, EPROM memory, EEPROM memory, register, hard disk, removable disk, CD-ROM, or any other type of recording medium known in the art. An exemplary recording medium is coupled to a processor which can read information from and record information to the recording medium. Alternatively, a recording medium may be integrated with a processor. A processor and a recording medium may be built in an application specific integrated circuit (ASIC). An ASIC may be built in a user terminal.

In describing embodiments hereinafter, when it is determined that the detailed description of a related known technology may obscure the gist of the embodiments disclosed herein, the detailed description thereof will be omitted. In addition, the accompanying drawings are provided only to help understanding of the embodiments disclosed herein, the technical spirit disclosed in the specification is not limited by the accompanying drawings, and all changes, equivalents, and substitutes of the embodiments will fall within the spirit and scope of the present invention.

It will be understood that although the terms first, second, etc. may be used herein to describe various elements, these elements should not be limited by these terms. These terms are only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

Examples of such an electronic device including an artificial intelligence technology described herein include a mobile phone, a smartphone, a laptop computer, an artificial intelligence device for digital broadcasting, a personal digital assistant (PDA), a portable multimedia player (PMP), a navigation device, a slate PC, a tablet PC, a Ultrabook computer, and a wearable device (e.g., smart watch, smart glass) or a head mounted display (HMD)).

In addition, examples of an electronic device including an artificial intelligence technology according to one embodiment described herein may include a stationary electronic device such as a smart TV, a desktop computer, a digital signage, and the like, and may also include a stationary or movable robot.

In addition, an electronic device including an artificial intelligence technology according to an embodiment described herein may have a function of a voice agent. The voice agent may be a program that recognizes a user's voice and outputs an appropriate response to the user's voice.

Artificial intelligence refers to the field of researching artificial intelligence or a methodology to create it, and machine learning refers to the field of researching methodologies to define and solve various problems that are dealt with in the field of artificial intelligence. Machine learning is defined as an algorithm that improves the performance of a task through a steady experience on a task.

Artificial Neural Network (ANN) is a model used in machine learning and may refer to an overall problem-solving model composed of artificial neurons (nodes) networked by synapses. The artificial neural network may be defined by a connection pattern between neurons of different layers, a learning process for updating model parameters, and an activation function for generating output values.

The artificial neural network may include an input layer, an output layer, and optionally one or more hidden layers. Each layer includes one or more neurons, and the artificial neural network may include synapses that connect neurons to neurons. In an artificial neural network, each neuron may output a function value of an active function for input signals, weights, and deflections input through a synapse.

The model parameter refers to a parameter determined through learning and includes weights of synaptic connections and deflections of neurons. In addition, a hyper parameter refers to a parameter to be set before learning in a machine learning algorithm, and may include a learning rate, a repetition count, a mini batch size, an initialization function, and the like.

The purpose of artificial neural network learning is to determine model parameters that minimize a loss function. The loss function may be used as an index for determining an optimal model parameter in the learning process of an artificial neural network.

Machine learning can be categorized into supervised learning, unsupervised learning, and reinforcement learning.

Supervised learning refers to a method of training an artificial neural network that is given a label for training data, and the label means a correct answer (or result value) that the artificial neural network must infer when the training data is input to the artificial neural network. Unsupervised learning refers to a method of training an artificial neural network without a label for training data. Reinforcement learning refers to a learning method that allows an agent defined in an environment to learn to choose an action or sequence of actions that maximizes cumulative reward in each state.

Machine learning which is implemented as a deep neural network (DNN) including a plurality of hidden layers among artificial neural networks is called deep learning. That is, deep learning is a part of machine learning. Hereinafter, the term “machine learning” will be used to refer to deep learning.

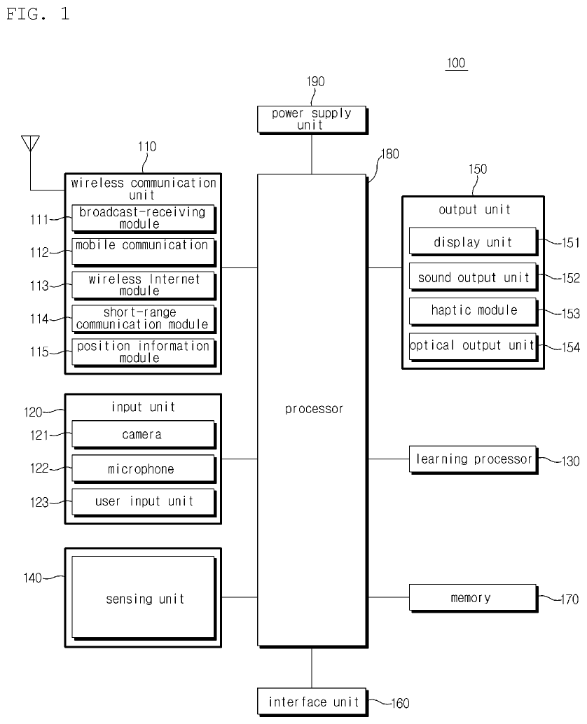

FIG. 1 is a block diagram of an electronic device 100 for speech recognition or voice recording, according to various embodiments of the present disclosure. The configuration of the electronic device 100 illustrated in FIG. 1 is one embodiment, and each component may be configured with one chip, component, or electronic circuit, or a combination of chips, components, or electronic circuits. According to another embodiment, each of several components illustrated in FIG. 1 may be divided into multiple elements and thus may be composed of different chips, components, or electronic circuits. On the other hand, several components illustrated in FIG. 1 may be combined to form a single chip, a part, or an electronic circuit. In addition, according to another embodiment, some of the components shown in FIG. 1 may be deleted or components not shown in FIG. 1 may be added to the configuration of FIG. 1. For example, when the electronic device is a personal computer, a wireless communication unit 110 shown in FIG. 1 may be deleted, and a wired communication unit such as Ethernet or LAN may be added instead of the wireless communication unit 110.

Referring to FIG. 1, the electronic device 100 for speech recognition or recording, according to various embodiments of the present disclosure, may include the wireless communication unit 110, an input unit 120, a learning processor 130, a sensing unit 140, an output unit 150, an interface unit 160, a memory 170, a processor 180, and a power supply unit 190.

According to various embodiments of the present disclosure, the wireless communication unit 110 may include at least one of a broadcast-receiving module 111, a mobile communication module 112, a wireless internet module 113, a short-range communication module 114, and a location information module 115.

The broadcast receiving module 111 may receive a broadcast signal, information on broadcast, or both from an external broadcast management server through a broadcast channel.

The mobile communication module 112 can receive and transmit a wireless signal to perform data communication with at least one of a base station, an external terminal, and a server on a mobile communication network constructed according to technical standards or communication schemes for mobile communication, such as Global System for Mobile communication (GSM), Code Division Multi Access (CDMA), Code Division Multi Access 2000 (CDMA2000), EV Enhanced Voice-Data Optimized or Enhanced Voice-Data Only (DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A).

The wireless internet module 113 refers to a module for wireless internet access and may be embedded in or external to the electronic device 100. The wireless internet module 113 may transmit and receive wireless signals for data communication on a communication network according to wireless internet technologies.

Wireless Internet technologies include, for example, Wireless LAN (WLAN), Wireless-Fidelity (Wi-Fi), Wi-Fi Direct, Digital Living Network Alliance (DLNA), Wireless Broadband (WiBro), and World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), and the like.

The short range communication module 114 enables short range communication by using at least one of the techniques of Bluetooth™, Radio Frequency Identification (RFID), Infrared Data Association (IrDA), Ultra-Wideband (UWB), ZigBee, Near Field Communication (NFI), Wireless-Fidelity (Wi-Fi), Wi-Fi Direct, Wireless Universal Serial Bus (Wireless USB).

The location information module 115 is a module for acquiring location information or determining current location of the electronic device 100. Examples of the location information module 115 include a global positioning system (GPS) module and a Wi-Fi module. For example, when the electronic device 100 utilizes a GPS module, the electronic device 100 may acquire the location information of the electronic device 100 on the basis of a signal transmitted from a GPS satellite.

The input unit 120 may include a camera 121 for inputting an image signal as input, a microphone 122 for inputting an audio signal as input, and a user input unit 123 for allowing a user to direct enter a command or information

Voice data or image data collected with the input unit 120 may be analyzed and processed according to a control command issued by a user.

The input unit 120 receives image information (or signal), audio information (or signal), data, or user-entered information. In order to receive image information, the electronic device 100 may be equipped with one or more cameras 121.

The camera 121 processes image frames of still images or moving images generated by an image sensor in video call mode or image capturing mode. The resulting image frames may be displayed on a display unit 151 or stored in the memory 170.

The microphone 122 processes external sound signals into electrical voice data. The resulting voice data may be utilized in various ways according to a function performed by the electronic device 100 or an application program being executed in the electronic device 100. Meanwhile, the microphone 122 is provided with various noise reduction algorithms to remove noise generated in the process of receiving an external sound signal.

The user input unit 123 receives information entered by a user. When information is input through the user input unit 123, the processor 180 may control the operation of the electronic device 100 according to the input information.

The user input unit 123 may be a touch input means or a mechanical input means such as a mechanical key, a button, a dome switch, a jog wheel, or a jog switch located on the front, rear, or side surface of the electronic device 100. As an example, the touch input means may be a virtual key, a soft key, or a visual key displayed on a touch screen through a software process, or a touch key arranged at portion other than the touch screen.

The learning processor 130 may be configured to receive, classify, store, and output information to be used for data mining, data analysis, intelligent decision making, and machine learning algorithms and techniques.

The learning processor 130 may include one or more memory units configured to store various data: for example, data that is received, detected, predefined, or output by the electronic device 100 employing artificial intelligence technology, data that is received, detected, predefined, or output by a different component, device, electronic device employing artificial technology: and data output by a device that communicates with an electronic device employing artificial technology.

The learning processor 130 may include a memory integrated with or implemented in the electronic device 100. In some embodiments, the learning processor 130 may be configured with the memory 170.

Alternatively, or additionally, the learning processor 130 may use memory associated with the electronic device 100, such as an external memory directly coupled to the electronic device 100, or a memory maintained in a server that communicates with the electronic device 100.

In another embodiment, the learning processor 130 may be implemented using a memory maintained in a cloud computing environment or a remote memory accessible by the electronic device 100 through a communication scheme such as a network.

The learning processor 130 is configured to store data in one or more databases to identify, index, categorize, manipulate, store, retrieve, and output the data for use in supervised or unsupervised learning, data mining, predictive analytics, or other electronic devices.

Information stored in the learning processor 130 may be utilized by the processor 180 or one or more other controllers of the electronic device 100, which uses any of a variety of different types of data analysis algorithms and machine learning algorithms.

Examples of such algorithms include k-nearest neighbor systems, fuzzy logic (for example, probability theory), neural networks, Boltzmann machines, vector quantization, pulse neural networks, support vector machines, maximum margin classifiers, hill climbing, inductive logic systems Bayesian networks, Petri net (for example, finite state machine, Millie machine, Moore finites state machine), classifier tree (for example, perceptron tree, support vector tree, Markov tree, decision-making tree forest, random forest), stake models and systems, artificial fusion, sensor fusion, image fusion, augmented learning, augmented reality, pattern recognition, and automated planning.

The processor 180 may determine or predict at least one executable operation of the electronic device 100 on the basis of data analysis or information determined or generated by a machine learning algorithm. To this end, the processor 180 may request, search, receive, or utilize data in the learning processor 130 and may control the electronic device 100 to perform a predicted operation of the executable operations or a desirable operation.

The processor 180 may perform various functions for implementing intelligent emulation (i.e., a knowledge-based system, an inference system, and a knowledge acquisition system). This can be applied to various types of systems (for example, fuzzy logic systems), adaptive systems, machine learning systems, artificial neural networks, and the like.

The processor 180 also may include a submodule enables voice and natural speech processing-involved operations, such as an I/O processing module, an environmental condition module, a voice-text (STT) processing module, a natural language processing module, a workflow processing module, and a service processing module.

Each of these submodules may have access to one or more systems or data and models in the electronic device 100, or to a subset or superset thereof. In addition, each of these submodules may provide various functions, including lexical indexes, user data, workflow models, service models, and automatic speech recognition (ASR) systems.

In another embodiment, the processor 180 or the electronic device 100 may be implemented as the submodule, system, or data and model.

In some examples, the processor 180 may be configured to detect and sense a request of a user by considering the intention of the user or contextual conditions (clues) expressed in user input or natural language that is entered by the user, on the basis of the data of the learning processor 130.

The processor 180 can actively derive and acquire the information needed to determine what the user requests, on the basis of contextual conditions (clues) or the intention of the user. For example, the processor 180 may actively derive the information needed to determine what the user requests by analyzing historical data, including historical input and output, pattern matching, unambiguous words, intents of the input, and the like.

The processor 180 may determine a flow of operations for executing a function that responses to the user's request, on the basis of the contextual conditions or the intention of the user.

In order to collect information to be processed or stored in the learning processor 130, the processor 180 may be configured to collect, sense, extract, detect, and/or receive signals or data used for data analysis and machine learning tasks through one or more sensing components in the electronic device 100.

Information collection may involve sensing information through a sensor, extracting information from the memory 170, or receiving information from another electronic device, entity, or external storage device via communication means.

The processor 180 may collect and store utilization history information of the electronic device 100.

The processor 180 may determine the best match to execute a specific function by using the utilization history information that is stored and predictive modeling.

The processor 180 may receive or detect surrounding environmental information (environmental parameters) or other information through the sensing unit 140.

The processor 180 may receive a broadcast signal and/or information on broadcast, a wireless signal, and wireless data through the wireless communication unit 110.

The processor 180 may receive image information (or a corresponding signal), audio information (or a corresponding signal), data or user-entered information from the input unit 120.

The processor 180 may collect information in real time, process or classify the information (for example, knowledge graph, command policy, personalization database, conversation engine, etc.), and store the processed information into the memory 170 or the learning processor 130.

When the operation of the electronic device 100 is determined by data analysis and machine learning algorithms and techniques, the processor 180 may control the components of the electronic device 100 to execute the determined operation. The processor 180 may perform the determined operation by controlling the electronic device 100 according to a control command.

When a specific operation is performed, the processor 180 analyzes history information indicating execution of the specific operation through data analysis and machine learning algorithms and techniques and updates the previously learned information on the basis of the analyzed information.

Accordingly, the processor 180 can improve, in conjunction with the learning processor 130, the accuracy of future performance through data analysis and machine learning algorithms and techniques on the basis of the updated information.

The sensing unit 140 may include one or more sensors for sensing at least one type of information contained in the electronic device 100, surrounding environment information of the electronic device 100, and user information.

For example, the sensing unit 140 may include at least one sensor selected from among a proximity sensor, an illumination sensor, a touch sensor, an acceleration sensor, a magnetic sensor, a gravity sensor (G-sensor), a gyroscope sensor, a motion sensor, an RGB sensor, an infrared sensor (IR sensor), a fingerprint scan sensor, a ultrasonic sensor, an optical sensor (for example, camera) (see reference numeral 121)), a microphone (see reference numeral 122), a battery gauge, environmental sensors (for example, barometers, hygrometers, thermometers, radiation sensors, heat sensors, gas sensors, etc.), and chemical sensors (for example, an electronic nose, a healthcare sensor, a biometric sensor, etc.). The electronic device disclosed herein may combine types of information sensed by at least two or more of those sensors for use of the information.

The output unit 150 is typically configured to output various types of information, such as audio, video, tactile output, and the like. The output unit 150 includes at least one of a display unit 151, a sound output unit 152, a haptic module 153, and an optical output unit 154.

The display unit 151 displays (outputs) information processed by the electronic device 100. For example, the display unit 151 may display execution screen information of an application program driven by the electronic device 100, or user interface (UI) or graphical user interface (GUI) information according to the execution screen information.

The display unit 151 may have an inter-layered structure or an integrated structure with a touch sensor, thereby implementing a touch screen. The touch screen may function as a user input unit 123 that provides an input interface between the electronic device 100 and the user and may also provide an output interface between the electronic device 100 and the user.

The audio output unit 152 may output audio data stored in the memory 170 or audio data received from the wireless communication unit 110 in a call signal reception mode, a call mode, a recording mode, a speech recognition mode, a broadcast reception mode, and the like.

The audio output unit 152 may include at least one device selected from among a receiver, a speaker, and a buzzer.

The haptic module 153 may generate various tactile effects that a user can feel. A representative example of the tactile effect generated by the haptic module 153 may be vibration.

The optical output unit 154 outputs a signal for notifying occurrence of an event by using light of a light source of the electronic device 100. Examples of the event generated in the electronic device 100 may include message reception, call signal reception, missed call, event notification, schedule notification, email reception, information reception through applications, and the like.

The interface unit 160 serves as a path to various types of external devices connected to the electronic device 100. The interface unit 160 may include at least one port selected among a wired/wireless headset port, an external charger port, a wired/wireless data port, a memory card port, a device connection port for connection with a device having an identification module, an audio input/output (I/O) port, a video I/O port, and an earphone port. In response to the connection of an external device to the interface unit 160, the electronic device 100 performs appropriate control related to the connected external device.

On the other hand, the identification module is a chip that stores a variety of information required to authenticate the electronic device 100. The identification module may include a user identity module (UIM), a subscriber identity module (SIM), a universal subscriber identity module (USIM), etc. A device equipped with an identification module (hereinafter referred to as an identification device) may be manufactured in the form of a smartcard. Therefore, the identification device may be connected to the electronic device 100 via the interface unit 160.

The memory 170 may store data required for implementing various functions of the electronic device 100. The memory 170 may store a plurality of application programs or applications that are driven by the electronic device 100, data used to operate the electronic device 100, instructions, and data (for example, information of at least one algorithm for machine learning) used to operate the learning processor 130.

In addition to the operations associated with the application programs, the processor 180 typically controls the overall operation of the electronic device 100. The processor 180 may provide appropriate information or functions to a user by processing signals, data, information, or the like input or output through the above-described components or by executing an application program stored in the memory 170.

In addition, the processor 180 may control at least some of the components shown in FIG. 1 to drive an application program stored in the memory 170. In addition, the processor 180 may operate at least two or more of the components included in the electronic device 100 in combination to drive the application program.

The power supply unit 190 may supply power to each of the component included in the electronic device 100 by receiving external power or internal power under the control of the processor 180. The power supply unit 190 includes a battery, which may be a built-in battery or a replaceable battery.

The processor 180 controls an operation associated with an application program and an overall operation of the electronic device 100. For example, when a mobile electronic device satisfies a preset condition, the processor 180 locks the electronic device so that inputting of a control command to the electronic device is restricted or unlocks the electronic device.

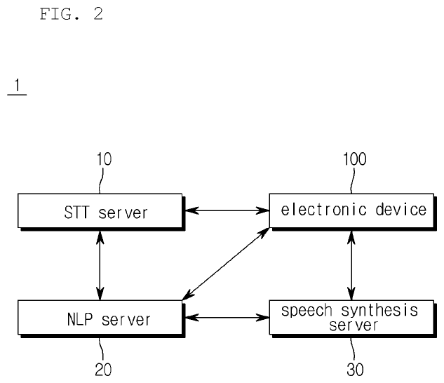

FIG. 2 is a diagram illustrating a voice system according to various embodiments of the present disclosure.

Referring to FIG. 2, a voice system 1 may include an electronic device 100 using artificial intelligence technology, a speech-to-text (STT) server 10, a natural language processing (NLP) server 20, and a speech synthesis server 30.

The electronic device 100 may transmit voice data to the STT server 10.

The STT server 10 may convert the voice data received from the electronic device 100 into text data.

The STT server 10 may increase the accuracy of speech-to-text conversion using a language model.

The language model means a model capable of calculating a probability of a sentence or calculating a probability of the next word when some words are given.

Examples of the language model include probabilistic language models such as a unigram model, a bigram model, an N-gram model, and the like.

The unigram model assumes that all words are completely independent of each other. The unigram model calculates the probability of a word sequence as the product of the probability of each word.

The bigram model is a model that assumes that the utilization of a given word depends only on one word that immediately precedes the given word.

The N-gram model is a model that assumes that the utilization of a given word depends on a plurality of (i.e., n-1) preceding words with respect to the given word. The STT server 10 may determine whether the text data resulting from the conversion of the voice data is properly converted data by using a language model, thereby increasing the accuracy of conversion of voice data into text data.

The NLP server 20 may receive the text data from the STT server 10. The NLP server 20 may perform intention analysis on the received text data.

The NLP server 20 may transmit intention analysis information that is the result of the intention analysis to the electronic device 100.

The NLP server 20 may generate the intent analysis information by performing a morphological analysis operation, a syntax analysis operation, a speech act analysis operation, and a dialogue processing operation on the text data.

The morpheme analysis operation classifies text data corresponding to speech spoken by a user into morpheme units, which are smallest units having meanings, and determines parts of speech of each classified morpheme.

The syntax analysis operation is an operation of dividing text data into noun phrases, verb phrases, adjective phrases, etc. using the results of the morphological analysis operation, and of determining what relation exists between each of the phrases.

Through the syntax analysis operation, the subject, object, and modifiers of the speech spoken by the user may be determined.

The speech act analysis operation is an operation of analyzing the intention of the speech spoken by the user using the results of the syntax analysis operation. Specifically, the speech act analysis operation may be an operation of determining the intention of the sentence, such as whether the user asks a question, makes a request, or expresses a simple emotion.

The dialog processing operation may be an operation of determining whether to answer the user's speech, respond to the speech, or ask a question for additional information by using the results of the speech act analysis operation.

After the dialog processing operation, the NLP server 20 may generate intention analysis information including at least one of answering, responding, and inquiring for additional information with respect to the intention of the speech of the user.

Meanwhile, the NLP server 20 may receive text data from the electronic device 100. For example, when the electronic device 100 supports a speech-to-text conversion function, the electronic device 100 may convert voice data into text data and transmit the resulting text data to the NLP server 20.

The speech synthesis server 30 may generate synthesized voice by combining the stored voice data.

The speech synthesis server 30 may record the voice (speech) of a person selected as a model and divide the recorded speech into syllables or words. The speech synthesis server 30 may store speech that is divided into syllables or words in an internal or external database on a per syllable or word basis.

The speech synthesis server 30 may search for syllables or words corresponding to given text data from a database and generate synthesized voice by synthesizing a combination of searched syllables or words.

The speech synthesis server 30 may store a plurality of speech language groups corresponding to various languages.

For example, the speech synthesis server 30 may include a first voice language group recorded in Korean and a second voice language group recorded in English.

The speech synthesis server 30 may translate text data of a first language into text data of a second language and generate synthesized speech corresponding to the text data of the second language by using the second speech language group.

The speech synthesis server 30 may transmit the generated synthesized speech to the electronic device 100.

The speech synthesis server 30 may receive intention analysis information from the NLP server 20.

The speech synthesis server 30 may generate synthesized speech reflecting the intention of the user on the basis of the intention analysis information.

According to one embodiment, the STT server 10, the NLP server 20, and the speech synthesis server 30 may be implemented as one server.

The functions of the STT server 10, the NLP server 20, and the speech synthesis server 30 described above may also be performed in the electronic device 100. To this end, the electronic device 100 may include a plurality of processors.

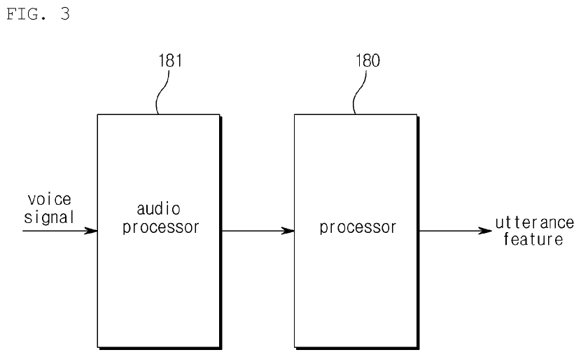

FIG. 3 is a diagram illustrating a process of extracting a speech feature of a user from a voice signal according to various embodiments of the present disclosure.

The electronic device 100 shown in FIG. 1 may further include an audio processor 181.

The audio processor 181 may be implemented as an additional chip independent of the processor 180 or as a chip included in the processor 180.

The audio processor 181 may remove noise from the voice signal.

The audio processor 181 may convert the voice signal into text data. To this end, the audio processor 181 may be provided with an STT engine.

The audio processor 181 may recognize an activation word for activating a speech recognition function of the electronic device 100. The audio processor 181 may convert the activation word received through the microphone 122 into text data and determine that the activation word is recognized when the text data resulting from the conversion is an activation word that is stored.

The audio processor 181 may convert a noise-removed voice signal into a power spectrum.

The power spectrum may be a parameter indicating which frequency components are included in what magnitude in a waveform of a voice signal that varies with time.

The power spectrum shows the distribution of squared values of amplitudes according to the frequencies of the waveforms of the speech signal.

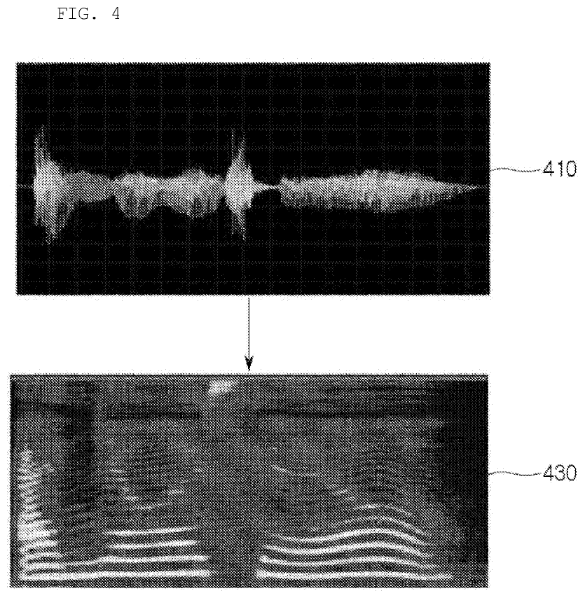

This will be described with reference to FIG. 4.

FIG. 4 illustrates an example in which a voice signal is converted into a power spectrum, according to an embodiment of the present disclosure.

FIG. 4 shows a voice signal 410. The voice signal 410 may be a signal received through the microphone 122 or a signal stored in the memory 170.

The x-axis of the voice signal 410 may represent time, and the y-axis may represent amplitude.

The audio processor 181 may convert the voice signal 410 in which the x axis represents time axis into a power spectrum 430 in which the x axis represents frequency.

The audio processor 181 may convert the voice signal 410 into the power spectrum 430 by using a Fast Fourier Transform (FFT).

The x-axis of the power spectrum 430 represents frequency, and the y-axis represents square value of amplitude.

Referring to FIG. 3, the processor 180 may determine the speech features of the user using the text data, the power spectrum 430, or both transmitted from the audio processor 181.

The speech features of the user may include the gender of the user, the voice pitch of the user, the voice tone of the user, the speech topic of the user, the speech rate of the user, and the voice volume of the user.

The processor 180 may acquire a frequency and a corresponding amplitude of the voice signal 410 from the power spectrum 430.

The processor 180 may determine the gender of the user (speaker) who has made the speech using the frequency band of the power spectrum 430.

For example, when the frequency band of the power spectrum 430 is within a preset first frequency band range, the processor 180 may determine the gender of the user as male.

When the frequency band of the power spectrum 430 is within a preset second frequency band range, the processor 180 may determine the gender of the user as female. Here, the second frequency band range may be a frequency band range higher than the first frequency band range.

The processor 180 may determine the pitch of the voice using the frequency band of the power spectrum 430.

For example, the processor 180 may determine the pitch of the sound on the basis of the magnitude of the amplitude within a specific frequency band range.

The processor 180 may determine the tone of the user using the frequency band of the power spectrum 430. For example, the processor 180 may determine a frequency band of which amplitude is greater than or equal to a predetermined amplitude among the frequency bands of the power spectrum 430 as a main vocal range of the user, and determine the determined main vocal range as the tone of the user.

The processor 180 may determine the speech rate of the user by counting the number of syllables spoken per unit time from the text data.

The processor 180 may determine a speech topic of the user from the text data by using a bag-of-word (BOW) model technique.

The BOW model technique is a technique of extracting frequently used words on the basis of the frequency of words in a sentence. Specifically, the BOW model technique is a technique of determining the feature of a speech topic by extracting a unique word in a sentence and expressing the frequency of each extracted word as a vector.

For example, when a word such as “running”, “fitness”, or the like frequently appears in the text data, the processor 180 may classify the speech topic of the user as exercise.

The processor 180 may determine a speech topic from the text data by using a text categorization technique. The processor 180 may extract a keyword from the text data to determine a speech topic of the user.

The processor 180 may determine the sound volume of the user by considering the amplitude information over the entire frequency band.

For example, the processor 180 may determine the sound volume of the user on the basis of an average or a weighted average of amplitudes in each frequency band of the power spectrum.

The functions of the audio processor 181 and the processor 180 described with reference to FIGS. 3 and 4 may be performed by any one of the NLP server 20 and the speech synthesis server 30.

For example, the NLP server 20 may extract the power spectrum from the voice signal and determine the speech features of the user by using the extracted power spectrum.

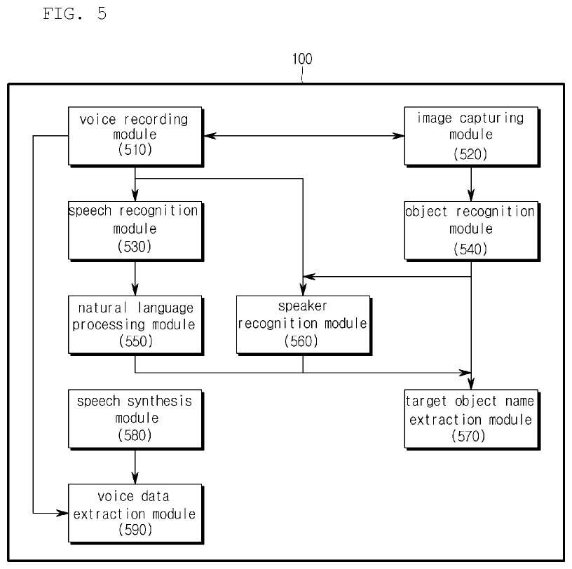

FIG. 5 is a block diagram illustrating operations performed by at least one processor of the electronic device 100 according to various embodiments of the present disclosure. The components illustrate in FIG. 5 are software program modules that can be executed by the processor 180, the learning processor 130 illustrated in FIG. 1, and/or the audio processor 181 illustrated in FIG. 3. Each of some components of the components may be implemented as a chip, ASIC, or FPGA dedicated to the component. In this case, the component may be considered as a hardware module. In addition, at least one processor may include a general-purpose processor, a chip designed to perform a specific function or configuration, an ASIC, or an FPGA. FIG. 5 is a diagram illustrating one embodiment. According to another embodiment, each of some components shown in FIG. 5 may be divided or distributed into separated several components, or several components shown in FIG. 5 may be combined into one component. According to another embodiment, some of the components shown in FIG. 5 may be deleted, or so components not shown in FIG. 5 may be added to the configuration of FIG. 5.

Referring to FIG. 5, the electronic device 100 that determines a target object referred to by a pronoun that is uttered by using artificial intelligence technology includes a voice recording module 510, an image capturing module 520, a speech recognition module 530, an object recognition module 540, a natural language processing module 550, a speaker recognition module 560, and a target object name extraction module 570. According to another embodiment, the electronic device 100 further includes a speech synthesis module 580 and a voice data substitution module 590 to record speech while replacing uttered pronouns with target object names.

According to various embodiments, the voice recording module 510 may record voice (speech) that is input through the microphone 122 of the input unit 120, and the image capturing module 520 may capture an image by controlling the camera 121 of the input unit 120 and acquire the captured images from the camera 121 of the input unit. In this case, the voice recording module 510 and the image capturing module 520 may be controlled to perform voice recording and image capturing in time synchronization with each other.

According to an embodiment of the present disclosure, the image capturing module 520 may include a plurality of cameras and may acquire a plurality of images captured by each of the cameras. When a plurality of cameras is used to capture images, the image capturing module 520 may set a direction in which each camera is directed for image capturing. For example, when the electronic device 100 is an automobile built-in device controlled by the voice of a driver of a vehicle, the electronic device 100 may include a front camera for monitoring the front side of the vehicle, side cameras for monitoring the sides of the vehicle, a rear camera for monitoring the rear side of the vehicle, and an interior camera for monitoring the interior of the vehicle, including the driver. As another example, when the electronic device 100 is an electronic device for recording a presentation, the electronic device 100 may include a presenter-tracking camera and an audience-capturing camera.

The speech recognition module 530 may analyze the voice data acquired by the voice recording module 510 and convert the voice data into text data. The speech recognition module 530 may increase the accuracy of speech-to-text conversion using a language model. The language model means a model capable of calculating a probability of a sentence or calculating a probability of the next word when some words are given. Examples of the language model include probabilistic language models such as a unigram model, a bigram model, an N-gram model, and the like. The speech recognition module 530 may determine whether the text data converted from the voice data is accurately converted by using the language model, thereby increasing the accuracy of conversion to the text data.

The speech recognition module 530 may increase the accuracy and reliability of conversion by applying artificial intelligence technology to conversion of voice data into text data using an artificial neural network.

In addition, according to another embodiment, the speech recognition module 530 does not attempt to recognize the speech from voice data by itself in the case of a lack of computing power of the electronic device 100, transmits the voice data to an external STT server S10 through the wireless communication unit 110, and receives the converted text data from the STT server S10.

The natural language processing module 550 may receive the converted text data from the speech recognition module 530 and perform analysis and extraction of meaningful data from the text data. The natural language processing module 550 not only generates the intention analysis information of the speaker but also extracts pronouns included in the voice data while performing morphological analysis, syntax analysis, speech act analysis, and dialogue processing analysis on the text data received from the speech recognition module 530.

In addition, the natural language processing module 550 may infer, from the context of the text data, the objects referred to by the respective pronouns extracted. According to an embodiment of the present disclosure, the natural language processing module 550 analyzes the context of each sentence for each pronoun extracted from the text data, creates a list of target objects referred to by the respective pronouns, and a table like Table 1 having confidence values or probability values of the respective target objects.

TABLE 1

| Candidate object | Smartphone | Camera | . . . |
|---|---|---|---|
| Confidence value | 0.69 | 0.23 | . . . |

The natural language processing module 550 may increase analysis performance by analyzing text data by using artificial intelligence technology and deep learning technology.

In addition, according to another embodiment, the natural language processing module 550 does not attempt to analyze the text data itself in the case of a lack of computing power of the electronic device 100. In that case, the natural language processing module 550 transmits the text data to the external NLP server 20 through the wireless communication unit 110, and controls the external NLP server 20 to perform a natural language processing function. According to another embodiment, the natural language processing module 550 is configured to perform an operation in which, when the voice data is converted into text data by the external STT server 10, the STT server 10 directly delivers the resulting text data to the NLP server 20. The natural language processing module 550 may acquire, from the NLP server 20, the pronouns included in the voice data and target object information that is assumed to be indicated by the pronouns from the context of the text data. For example, in a case where a speaker makes the speech “I would like to introduce a new refrigerator developed by the company today. This is a product with artificial intelligence technology applied.”, the natural language processing module 550 infers that the pronoun “this” refers to the word “refrigerator” from the context. That is, the target object indicated by the pronoun “this” is inferred to be the refrigerator.

The object recognition module 540 may find a location and type of a meaningful object in at least one image acquired by the image capturing module 520. According to an embodiment of the present disclosure, the object recognition module 540 may classify objects existing in images, such as people like speakers, visual data, and other objects and determine the location and type of each of the objects. According to another embodiment, the object recognition module 540 may recognize objects on a per image frame basis.

The object recognition module 540 may use a conventional vision algorithm. Alternatively, the object recognition module 540 may use artificial intelligence technology such as a deep neural network, a convolutional neural network, or the like.

When the speaker recognition module 560 specifies a speaker through face recognition from an image on the basis of the location information of the speaker when acquiring voice data from the voice recording module 510 when the objects recognized by the object recognition module 540 include at least one person. In one embodiment, the speaker recognition module 560 determines whether a person is recognized in an area in which a speaker is expected to be present in the image on the basis of the location information, and, when a person is recognized, specifies the speaker by determining whether the lips in the face of the speaker are moving.

The speaker recognition module 560 may acquire information on a target object corresponding to a pronoun spoken by the speaker through face and eye tracking and hand and/or arm gesture recognition when a speaker is specified. According to an embodiment of the present disclosure, the speaker recognition module 560 may detect a gaze of a speaker through tracking of facial orientation and pupils and identify a position (coordinate or area) that is the target of the gaze. According to another embodiment, the speaker recognition module 560 may identify a position (coordinate or area) pointed at by a finger, a hand, or an object in the hand. According to another embodiment, the speaker recognition module 560 may identify the position of a target object on the basis of both the detection of line of slight through tracking of the face direction and movement of pupils and of the direction pointed at by a finger, a hand, or an object in the hand. The speaker recognition module 560 may display an area in which a target object is assumed to be present in the image on the basis of the identified position. According to an embodiment of the present disclosure, the position directed by the eyes of a speaker or pointed at by a finger, hand, or object in the hand may not be in the same image as the image in which the speaker is present but may be in a different image captured by another camera from the image in which the speaker is present. The speaker recognition module 560 may determine whether the position directed by the eyes of the speaker or pointed at by the speaker and the position in which the speaker is present are within the same image captured by the same camera or in different images captured by different cameras on the basis of the directions of the cameras which are preset. For example, when the driver of a car says, “What is the number of the restaurant?”, the speaker recognition module 560 recognizes the speaker through an interior image captured by the interior camera that monitors the interior of the vehicle and the driver and recognizes the position of the restaurant (corresponding to a target object) through a side image captured by the side camera on the basis of the direction of eyes of the speaker.

According to an embodiment of the present disclosure, the speaker recognition module 560 and the object recognition module 540 may be combined into one module.

The target object name extraction module 570 may acquire pronouns extracted by the natural language processing module 550 and first target object assumption information of the corresponding pronouns, which is assumed from the context in the text data. In addition, the target object name extraction module 570 may acquire information on objects being present in an area as second target object assumption information on the basis of an area in which the target objects displayed on the speaker recognition module 560 are assumed to be present and the object information acquired by the object recognition module 540. According to an embodiment of the present disclosure, the target object name extraction module 570 compares the first target object assumption information and the second target object assumption information, and determines the object included in both the first target object assumption information and the second target object assumption information, and specifies the name of the target object which will be simply called “target object name” hereinafter. According to another embodiment, the target object name extracting module 570 finally determines the object included in the first target object assumption information as the target object corresponding to the pronoun spoken by the speaker when there is no object that is included in both of the first target object assumption information and the second target object assumption information.

When the target object finally assumed to correspond to the pronoun spoken by the speaker is an object the name of which is previously spoken, the target object name extraction module 570 specifies the name as a target object name that will replace the pronoun during the recording. According to another embodiment of the present disclosure, the target object name extraction module 570 may assign a new name when the last assumed target object of the spoken pronoun is not a previously named object. The target object name extraction module 570 may assign a new name in the form of an object name followed by a number in order (i.e., name+number) or in the form of an object name followed by an alphabetical character (i.e., name+alphabet). For example, when the target object corresponding to the pronoun spoken is a camera, the target object may be named simply “camera”. However, when a plurality of cameras is recognized by the object recognition module 540, the target object may be named “camera 1” or “camera a”. In another example, the target object name extraction module 570 may give a name “chair” when the target object corresponding to the spoken pronoun is a chair. Subsequently, when a target object corresponding to another pronoun is a different chair, the target object name extraction module 570 may name this chair a different name (for example, “chair 1” or “chair a”) to distinguish this chair from the previously recognized chair that is named simply “chair”.

The processor 180 of the electronic device 100 may display a pronoun occurring in the voice data generated by the voice recording module 510 or a pronoun occurring in the text data generated by the speech recognition module 530 to show a target object name (name of a target object) corresponding to the pronoun. In one embodiment, each of the pronouns in voice data or text data may be replaced with a corresponding one of the target object names. In another embodiment, footnotes may be attached to pronouns in voice data or text data to inform the corresponding target object names. In a further embodiment, target object names corresponding to the respective pronouns in voice data or text data may be displayed in the form of memos. In a further embodiment, a hypertext showing the corresponding target object may be displayed in association with the pronoun occurring in voice data or text data.

The electronic device 100 may additionally include a speech synthesis module 580 and a voice data substitution module 590 to replace pronouns in voice data with corresponding target object names.

The speech synthesis module 580 may convert the target object name determined by the target object name extraction module 570 into voice. The speech synthesis module 580 may synthesize the stored voice data to generate synthesized speech. According to an embodiment, when the target object name corresponding to the uttered pronoun is already included in the voice data acquired by the voice recording module 510, the speech synthesis module 580 may extract the corresponding target object name and use it for speech synthesis. According to an embodiment, when the target object name of the spoken pronoun is the same as one of the contextually assumed target object names acquired by the natural language processing module 550, the corresponding target object name included in the context is extracted from the voice data, and a synthesized voice of the target object name which is a combination of the actual name of the target object and a number or alphabetical character. According to another embodiment, the speech synthesis module 580 records speech of a person selected as a model, divides the recorded speech into syllables or words, and stores the audio data of the spoken syllables or words in an internal or external database. The speech synthesis module 580 may search for syllables or words corresponding to the given text data from a database, synthesize the found syllables or words, and generate synthesized speech. According to an embodiment of the present disclosure, the speech synthesis module 580 may generate speech that is the utterance of the target object name in compliance with the tone or speech features of the speaker on the basis of the voice data analysis performed by the natural language processing module 550.

The voice data substitution module 590 may acquire voice data by using the voice recording module 510 and replace the spoken pronoun with a target object name synthesized by the speech synthesis module 580. In one embodiment, the voice data substitution module 590 replaces the utterance of the pronoun with the utterance of the corresponding target object name by cutting out the power spectrum of the voice of the pronoun and inserting the power spectrum of the voice of the synthesized target object name.

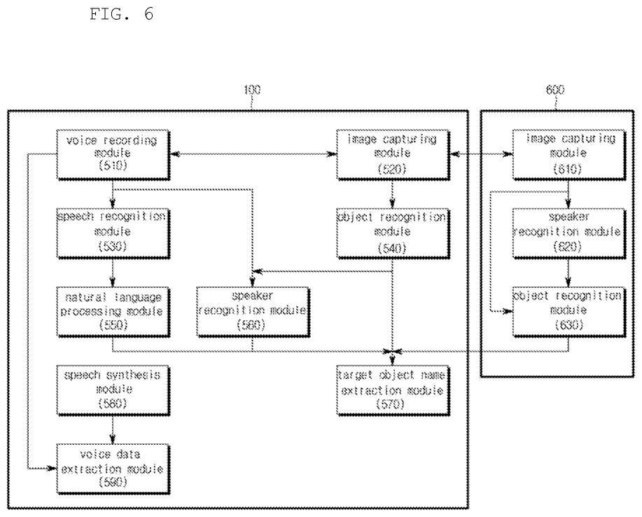

FIG. 6 is a block diagram illustrating a configuration in which at least one processor of the electronic device 100 and a processor of an additional device 600 connected to the electronic device 100 operate in conjunction with each other to determine an object indicated by a pronoun. According to an embodiment of the present disclosure, the additional device 600 may be a notebook, a personal computer, or a smartphone, or the like on which visual data can be displayed. The presenter is likely to be presenting in the vicinity of or in front of the additional device 600. Therefore, it may be much more efficient for the additional device 600 to recognize the speaker (i.e., presenter). Therefore, the reliability of determination of the speaker indicated by the pronoun may be improved by allowing the additional device 600 to acquire target object information indicated by the spoken pronoun.

Referring to FIG. 6, the additional device 600 may include an image capturing module 610, a speaker recognition module 620, and an object recognition module 630.

According to an embodiment of the present disclosure, the speaker recognition module 620 of the additional device 600 may have the same configuration as the speaker recognition module 560 of the electronic device 100, and the object recognition module 630 of the additional device 600 may have the same configuration as the object recognition module 540 of the electronic device 100.

The image capturing module 610 may capture an image by controlling a built-in camera in a manner that the image captured by the built-in camera and the image captured by the electronic device 100 are synchronized in time. According to an embodiment of the present disclosure, since the speaker is generally in front of the additional device 600, only the speaker may be included in the image captured by the image capturing module 610.

The speaker recognition module 620 may determine whether a person which is in front of the image capturing module 610 is an actual speaker by recognizing the face and the behavior of the person. In addition, the speaker recognition module 620 may find the location indicated by the speaker through tracking of the face and gaze of the speaker or the motion recognition of the hand and/or arm of the speaker in the images being captured by the image capturing module 610. According to an embodiment of the present disclosure, the speaker recognition module 620 may detect a gaze of the speaker through tracking of the facial orientation and pupils and specify a position (coordinate or area) that is the target of the gaze. According to another embodiment, the speaker recognition module 560 may specify a position (coordinate or region) pointed at by a finger, a hand, or an object in the hand. According to a further embodiment, the speaker recognition module 620 may specify the position on the basis of both the detection of the gaze of the speaker through tracking of the facial orientation and pupils and the detection of the direction of a finger, a hand, or an object in a hand. In this case, the position pointed at by the speaker may be a specific location at which visual material is displayed, in the entire area of the screen of the additional device 600.

The object recognition module 630 may recognize an object in the content displayed on the screen of the additional device 600. According to an embodiment of the present disclosure, the object recognition module 630 may recognize a position within a screen, which is pointed at by a specific speaker specified by the speaker recognition module 620 and may recognize an object being present at the position.

The additional device 600 may transmit the object recognized by the object recognition module 630 to the electronic device 100. The transmission of information between the additional device 600 and the electronic device 100 may be performed by wireless communication or wired communication. According to an embodiment, the electronic device 100 may acquire information on the recognized object by communicating with the additional device 600 through the wireless communication unit 110.

According to an embodiment of the present disclosure, the speaker recognition module 620 and the object recognition module 630 of the additional device 600 may be integrated into one module.

The target object name extraction module 570 of the electronic device 100 may extract the target object name by additionally referring to the object information acquired from the additional device 600.

The target object name extraction module 570 may acquire pronouns extracted by the natural language processing module 550 and first target object assumption information of the corresponding pronouns, which is assumed from the context in the text data. In addition, the target object name extraction module 570 may acquire information on objects being present in an area as second target object assumption information on the basis of an area in which the target objects displayed on the speaker recognition module 560 are assumed to be present and the object information acquired by the object recognition module 540. In addition, the target object name extraction module 570 may extract target objects acquired from the additional device 600 as third target object assumption information. According to an embodiment, the target object name extraction module 570 may compare the first target object assumption information, the second target object assumption information, and the third target object assumption information, determines an object that is included in all of the three types of information as a target object indicated by a specific spoken pronoun, and determines the name of the object. According to another embodiment, the target object name extraction module 570 determines a target object by placing different weighting factors to the recognized objects according to whether a speaker recognized by the speaker recognition module 560 and a speaker recognized by the speaker recognition module 620 of the additional device 600 are the same. According to one embodiment, when the speaker recognized by the speaker recognition module 560 is the person who is present in front of the additional device 600 and who is recognized by the speaker recognition module 620 of the additional device 600, a higher weighting factor may be applied to the object recognized by the additional device 600. According to another embodiment, when the speaker recognized by the speaker recognition module 560 is not the person who is present in front of the additional device 600 and who is recognized by the speaker recognition module 620 of the additional device 600, the electronic device 100 may apply a higher weighting factor to the object recognized by the electronic device 100.

According to various embodiments of the present disclosure, an electronic device (for example, the electronic device 100 of FIG. 1) may comprise an image capturing unit (for example, the camera 121 of FIG. 1) configured to capture one or more images, a microphone (for example, the microphone 1 of FIG. 1) configured to acquire speech and at least one processor (for example, the processor 180 of FIG. 1, the learning processor 130, and the audio processor 181 of FIG. 3) that is operatively connected to the image capturing unit and the microphone.

The at least one processor may be configured to acquire the speech through the microphone, generate text data from the acquired speech, generate a pronoun list and first target object assumption information from the generated text data, wherein the first target object assumption information includes target objects assumed to be referred to by respective pronouns in the pronoun list based on contextual information from the generated text data, recognize one or more objects from the one or more images captured by the at least one camera, recognize a speaker from among the recognized one or more objects, generate second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition, determine target objects referred to by the respective pronouns and determine target object names corresponding to the determined target objects based on the generated first target object assumption information and the generated second target object assumption information.

According to various embodiments, the at least one processor may be further configured to replace audio portions including pronouns in the acquired speech with corresponding generated voice representations of the determined target object names or replace textual portions including the pronouns from the generated text data with corresponding text representations of the determined target object names.

According to various embodiments, the at least one processor may be further configured to associate at least one of an object image, a memo, or a hypertext representing a determined target object name to a corresponding pronoun in the generated text data.

According to various embodiments, the at least one processor may be further configured to analyze a context of a sentence associated with each pronoun in the pronoun list, generate a target object list based on the generated second target object assumption information, wherein the target object list includes particular objects assumed to be indicated by the respective pronouns in the pronoun list and generate confidence values for the particular target objects in the target object list based on a result of the analysis.

According to various embodiments, the at least one processor may extract the second target object assumption information including the target object list and the confidence values of the respective target objects listed in the target object list.

According to various embodiments, the generating the second target object assumption information may comprise detecting the gaze of the recognized speaker by tracking facial orientation and pupils of the recognized speaker from the one or more captured images, determining a first position corresponding to a target of the gaze of the recognized speaker or a second position indicated by the recognized speaker and setting an area of a predetermined size in a vicinity of at least one of the first position or the second position, wherein the second target object assumption information is generated based on recognizing particular objects in the set area.

According to various embodiments, the electronic device further comprises a plurality of cameras each facing different orientations, wherein the one or more processors are further configured to recognize the one or more objects by detecting the gaze of the recognized speaker by tracking facial orientation and pupils of the recognized speaker in a first image in which the recognized speaker is included from among the one or more images captured by the plurality of cameras, determining a first position corresponding to a target of the gaze of the recognized speaker or a second position indicated by the recognized speaker, recognizing a second image including at least one of the first position or the second position from among the captured one or more images based at least in part on the orientation of each of the plurality of cameras and setting an area of a predetermined size in a vicinity of at least one of the first position or the second in the second image, wherein the second target object assumption information is generated based on recognizing particular objects in the set area.

According to various embodiments, when the same target object is included in the first target object assumption information and the second target object assumption information, the at least one processor may determine that the same target object as a target object indicated by a pronoun contained in the pronoun list.

According to various embodiments, the at least one processor may be further configured to determine that a specific target object from among the determined target objects as an object indicated by a corresponding one of the pronouns in the pronoun list when the specific target object is included in both the first target object assumption information and the second target object assumption information.

According to various embodiments, the one or more objects is recognized from the captured one or more images by using artificial intelligence and the speaker is recognized from the recognized one or more objects by using artificial intelligence.

According to various embodiments, recognizing the speaker from among the recognized one or more objects comprises acquiring position information of the speaker when the speech is acquired through the microphone and determining whether a person is detected in an area in which the speaker is expected to be present within the captured one or more images based on the acquired position information of the speaker; wherein the speaker is recognized by determining that lips of the detected person in the area are moving when the detected person is present within the captured one or more images.

According to various embodiments, the at least one processor may be further configured to obtain third target object assumption information from an external device, and wherein the target objects are determined based at least in part on the first target object assumption information, the second target object assumption information, and the third target object assumption information.

According to various embodiments, the electronic device may comprises a camera configured to capture one or more images, a microphone configured to acquire speech, a communication unit (for example, the wireless communication unit 110 of FIG. 1) capable of communicating with external devices, and the at least one processor configured to acquire the speech through the microphone, transmit the acquired speech to an external speech-to-text (STT) server via the communication unit, obtain, from the STT server, text data from the acquired speech, transmit the obtained text data to an external natural language processing (NLP) server via the communication unit, obtain, from the NLP server, a pronoun list and a first target object assumption information from the text data, wherein the first target object assumption information includes target objects assumed to be referred to by respective pronouns in the pronoun list based on contextual information from the obtained text data, recognize one or more objects from the one or more images captured by the camera, recognize a speaker from among the recognized one or more objects, generate second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition, determine target objects referred to by the pronouns, and determine target object names corresponding to the determined target objects based on the obtained first target object assumption information and the generated second target object assumption information.

As described above, various embodiments presented in the present disclosure can more accurately determine a target object indicated by a pronoun included in uttered speech, thereby enabling a voice agent to clearly understand the user's intention and to replace the pronoun included in the uttered speech with a corresponding target object name during voice recording so that listeners can easily understand the content of the speech because the names of the target objects corresponding to the respective pronouns are explicitly expressed.

Hereinafter, a method of operating the electronic device 100 to determine a target object indicated by a pronoun included in uttered speech will be described.

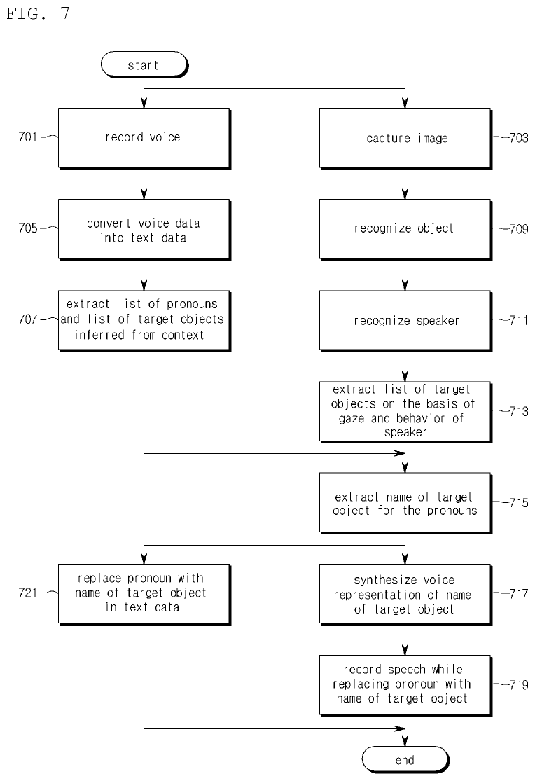

FIG. 7 is a flowchart illustrating a method of determining, by an electronic device 100, a target object indicated by a pronoun included in uttered speech according to various embodiments of the present disclosure. Each configuration of the flowchart of FIG. 7 may be implemented as at least one processor (for example, the processor 180 of FIG. 1, the learning processor 130, and the audio processor 181 of FIG. 3) included in the electronic device 100, an ASIC, or FPGA.

Referring to FIG. 7, in operation 701, the electronic device 100 may perform voice recording and in operation 703, the electronic device 100 may perform image capturing (that is, video recording). At this time, the voice recording and the image capturing (video recording) may be time-synchronized. According to an embodiment of the present disclosure, the electronic device 100 may perform the voice recording of operation 701 and the image capturing of operation 703 by using two separate functions. According to another embodiment, the electronic device 100 may perform the voice recording of operation 701 and the image capturing of operation 703 by using one function. For example, the electronic device 100 may operate a camera to acquire an image and an audio signal. The electronic device 100 may separate the image and the audio signal although they are recorded as one file and may use only the audio signal later. According to another embodiment, in operation 703, the electronic device may capture images in a plurality of directions using a plurality of cameras. For example, an electronic device provided in a vehicle and configured to perform an operation of responding to a voice command of a driver may include a front camera for photographing the front of the vehicle, a side camera for photographing the side of the vehicle, a rear camera for photographing the rear of the vehicle, and an interior camera for photographing the interior of the vehicle and the driver. As another example, when the electronic device 100 is an electronic device for recording a presentation, the electronic device 100 may include a presenter-tracking camera and an audience-capturing camera.

In operation 705, the electronic device 100 may recognize the recorded voice and convert the recorded voice into text data. According to one embodiment, the electronic device 100 may use artificial intelligence technology for speech recognition and conversion of the recorded voice into text data. The electronic device 100 may increase the accuracy of speech-to-text conversion using a language model. The language model means a model capable of calculating a probability of a sentence or calculating a probability of the next word when some words are given. Examples of the language model include probabilistic language models such as a unigram model, a bigram model, an N-gram model, and the like.

In operation 707, the electronic device 100 may extract a list of pronouns occurring in the text and a list of target objects corresponding to the pronouns, which are inferred from the context of the text data obtained in operation 705. According to an embodiment of the present disclosure, the electronic device 100 may perform meaningful data analysis and extraction from text data using a natural language processing function to which artificial intelligence technology is applied. The natural language processing function of the electronic device 100 may analyze the intention of a speaker while performing morphological analysis, parsing (syntax analysis), speech act analysis, and dialogue processing analysis on the text data, and may extract pronouns included in the text data. In addition, the natural language processing function of the electronic device 100 may assume an object contextually indicated by each pronoun. According to an embodiment of the present disclosure, the electronic device 100 analyzes the context of a sentence for each pronoun extracted from text data, and generates a table having a list of target objects indicated by pronouns and probability values each indicating a confidence value or probability of a corresponding one of the target objects.

In operation 709, the electronic device 100 may recognize objects included in the captured image. According to an embodiment of the present disclosure, the electronic device 100 may acquire position information and type information of meaningful objects included in the captured image. The electronic device 100 may recognize a type and a position of a target object by classifying people including a speaker, visual material, and other various objects existing in the captured image. According to an embodiment of the present disclosure, when a plurality of images is captured by a plurality of cameras, the electronic device 100 may separately recognize objects included in each of the images.

In operation 711, the electronic device 100 may identifies a speaker through face recognition based on the image by referring to the position information of the speaker acquired during the voice recording in operation 701 among the objects recognized in operation 709. According to one embodiment of the present disclosure, the electronic device 100 determines whether a person is recognized in the direction in which the speaker is expected to be present on the basis of the position information of the speaker. When a person is recognized, the electronic device 100 determines whether the lips of the person are moving.

In operation 713, the electronic device 100 may extract a target assumption list that is a list of target objects assumed to be indicated by the respective pronouns on the basis of the gaze and behavior of the speaker who is recognized in operation 711. According to an embodiment, the electronic device 100 may detect a gaze through tracking of facial orientation and pupils and identify a position (coordinate or area) that is the target of the gaze. According to another embodiment, the electronic device 100 may identify a position (coordinate or area) pointed at by the finger, hand, or object in the hand of the identified speaker. According to another embodiment, the electronic device 100 may identify a location pointed at by a speaker who makes an utterance of a pronoun on the basis of the gaze and behavior of the recognized speaker. The electronic device 100 may display an area in which the target object is assumed to be present in the image on the basis of the identified position. According to an embodiment, when a plurality of images is used, an image having a speaker and an image having a location pointed at by the speaker may be different. The electronic device 100 may set a direction of a location photographed by each of the plurality of cameras, and the electronic device 100 may determine that the location pointed at by the speaker exists in a different image on the basis of the direction information of each camera. In addition, the electronic device 100 may identify an area in which a target object is assumed to be present within the image.

The electronic device 100 may compare the area in which a target object is assumed to be present with the position of the object recognized in operation 709, assume the objects located in the area as target objects indicated by the respective uttered pronouns, and extract a list of target objects.

In operation 715, the electronic device 100 may extract a target object name corresponding to the uttered pronoun. The electronic device 100 may acquire second target object assumption information of objects included in an area pointed at by a speaker on the basis of the first target object assumption information of the corresponding pronouns acquired in operation 707 and object recognition information acquired in operation 712. The electronic device 100 may compare the first target object assumption information and the second target object assumption information, finally assume an object included in both of the first target object assumption information and the second target object assumption information as a target object indicated by an uttered pronoun, and specify the name of the object. According to another embodiment, when there is no object included in both the first target object assumption information and the second target object assumption information, the electronic device 100 prioritizes an object included in the first target object assumption information, determines the object as the target object of the uttered pronoun, and specifies the name of the object.

According to another embodiment, the electronic device 100 may acquire third target object assumption information from an external device (for example, the additional device 600 of FIG. 6). The third target object assumption information may be, for example, information estimated by the additional device 600 that displays visual material. The additional device 600 may include a camera and recognize a user who is in front of the additional device 600 from an image captured by the camera. In addition, the additional device 600 may determine whether the user who is in front of the additional device 600 is a speaker on the basis of the face and behavior of the user. When it is determined that the user who is in front of the additional device 600 is a speaker, the additional device 600 may determine an area on the screen on which a visual material pointed at by the speaker is displayed, on the basis of the gaze and/or behavior of the speaker. The additional device 600 may recognize an object existing in an area and transmit the recognized object as third target object assumption information to the electronic device 100. According to another embodiment, regardless of the determination of whether the user in front of the additional device 600 is a speaker, the additional device 600 determines an area on the screen, which is pointed at by the user who is present in front of the additional device 600, and transmits an object in the area as third target object assumption information to the electronic device 100.

In operation 715, the electronic device 100 compares the first target object assumption information, the second target object assumption information, and the third target object assumption information acquired from the additional device 600, finally determines an object included in all of the first target object assumption information, the second target object assumption information, and the third target object assumption information as a target object indicated by an uttered pronoun, and specifies the name of the object. According to another embodiment, the electronic device 100 may determine a target object by assigning different weighting factors to the recognized objects according to whether the speaker recognized by the electronic device 100 and the speaker recognized by the additional device 600 are the same person. According to one embodiment, when a speaker recognized by the electronic device 100 is a user who is recognized by the additional device 600 and is present in front of the additional device 600, the object recognized by the additional device 600 is given a high weighting factor. According to another embodiment, when a speaker recognized by the electronic device 100 is not a user who is recognized by and is present in front of the additional device 600, the object recognized by the electronic device 100 is given a high weighting factor.

The electronic device 100 may further increase the accuracy in recognizing an object corresponding to a pronoun based on the cooperation of the additional device 600. When a finally determined target object corresponding to an uttered pronoun is an object that has been previously given a name, the electronic device 100 may specify the name as a name to replace the uttered pronoun. According to another embodiment, the electronic device 100 may give a new name when the finally determined target object corresponding to the uttered pronoun is not an object that has been previously given a name. The electronic device 100 may assign a new name having the form “name of an object and a number” or “name of an object and an alphabetical character”.

The electronic device 100 may display the names of target objects indicated by respective pronouns in voice data recorded in operation 701 and respective pronouns in text data generated in operation 705. In one embodiment, each of the pronouns in voice data or text data may be replaced with a corresponding one of the target object names. In another embodiment, footnotes may be attached to pronouns in voice data or text data to inform the corresponding target object names. In a further embodiment, target object names corresponding to the respective pronouns in voice data or text data may be displayed in the form of memos. In a further embodiment, a hypertext showing the corresponding target object may be displayed in association with the pronoun occurring in voice data or text data.

According to an embodiment, the electronic device 100 may perform an operation of replacing a pronoun in the recorded voice data with a corresponding target object name. In operation 717, the electronic device 100 may perform speech synthesis on the extracted target object name. The electronic device 100 may combine stored voice data to generate synthesized speech. According to one embodiment, when the target object name corresponding to the uttered pronoun is already included in the voice data acquired in operation 701, the electronic device 100 may extract the corresponding target object name and use the same for speech synthesis. According to one embodiment, when the target object name corresponding the uttered pronoun is the same as one of the contextually estimated target object names acquired in operation 707, the corresponding object name included in the context is extracted from the voice data, and synthesized speech corresponding to the target object name which is a combination of the extracted object name and a number or an alphabetical character is generated. According to another embodiment, the electronic device 100 records the voice (i.e., speech) of a person selected as a model, divides the recorded voice into syllables or words, and stores the voice representations of the syllables or words into an internal or external database. The speech synthesis module 580 may search the database for syllables or words that are included in the corresponding object name, synthesize voice (speech) corresponding to a combination of the found syllables or words, and generate synthesized speech. According to one embodiment, the electronic device 100 may generate a voice of uttering a target object name while mimicking the voice tone or utterance feature of the speaker on the basis of the voice data analysis performed in operation of 707.

In operation 719, the electronic device 100 may replace the pronouns included in the voice data with the respective target object names during voice recording. The electronic device 100 performs voice recording while replacing the uttered pronouns In the voice record acquired in operation 701 with the synthesized voice representations of the respective target object names synthesized in operation 717 and stores a new voice record in which the pronouns are replaced with the respective target object names. According to one embodiment, the electronic device 100 may replace an uttered pronoun with a synthesized voice of the corresponding target object name in a manner of cutting out the power spectrum of the uttered pronoun and inserting the power spectrum of the synthesized voice of the corresponding target object name.

According to one embodiment, the electronic device 100 may perform an operation of replacing a pronoun included in text data with a corresponding target object name. In operation 721, the electronic device 100 may replace the pronoun extracted in operation 707 from the text data obtained in operation 705 with the corresponding target object name extracted in operation 715. This makes a user to clearly understand what an uttered pronoun indicates even though the circumstance in which the voice (speech) is recorded is not known.

Although the operations illustrated in FIG. 7 are illustrated as being sequentially performed, some operations may be performed simultaneously or may be performed in different order from the order shown in FIG. 7. In addition, some of the operations shown in FIG. 7 may not be performed, or operations not shown in FIG. 7 may be additionally performed.

According to various embodiments, a method of operating an electronic device (for example, the electronic device 100 of FIG. 1) may comprise acquiring speech through a microphone, generating text data from the acquired speech, generating a pronoun list and first target object assumption information from the generated text data, wherein the first target object assumption information includes target objects assumed to be referred to by respective pronouns in the pronoun list based on contextual information from the generated text data, recognizing one or more objects from one or more images captured by at least one camera, recognizing a speaker from among the recognized one or more objects, generating second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition, determining target objects referred to by the respective pronouns and determining target object names corresponding to the determined target objects based on the generated first target object assumption information and the generated second target object assumption information.

According to various embodiments, the method may further comprise replacing audio portions including pronouns in the acquired speech with corresponding generated voice representations of the determined target object names or replacing textual portions including the pronouns from the generated text data with corresponding text representations of the determined target object names.

According to various embodiments, the method may further comprise associating at least one of an object image, a memo, or a hypertext representing a determined target object name to a corresponding pronoun in the generated text data.

According to various embodiments, the method may further comprise analyzing a context of a sentence associated with each pronoun in the pronoun list, generating a target object list based on the generated second target object assumption information, wherein the target object list includes particular objects assumed to be indicated by the respective pronouns in the pronoun list and generating confidence values for the particular target objects in the target object list based on a result of the analysis.

According to various embodiments, the generating the second target object assumption information may comprise detecting the gaze of the recognized speaker by tracking facial orientation and pupils of the recognized speaker from the one or more captured images, determining a first position corresponding to a target of the gaze of the recognized speaker or a second position indicated by the recognized speaker and setting an area of a predetermined size in a vicinity of at least one of the first position or the second position, wherein the second target object assumption information is generated based on recognizing particular objects in the set area.

According to various embodiments, the one or more objects are recognized by detecting the gaze of the recognized speaker by tracking facial orientation and pupils of the recognized speaker in a first image in which the recognized speaker is included from among one or more images captured by a plurality of cameras, wherein the plurality of cameras each face different orientations, determining a first position corresponding to a target of the gaze of the recognized speaker or a second position indicated by the recognized speaker, recognizing a second image including at least one of the first position or the second position from among the captured one or more images based at least in part on the orientation of each of the plurality of cameras and setting an area of a predetermined size in a vicinity of at least one of the first position or the second in the second image, wherein the second target object assumption information is generated based on recognizing particular objects in the set area.

According to various embodiments, the method may further comprise determining that a specific target object from among the determined target objects as an object indicated by a corresponding one of the pronouns in the pronoun list when the specific target object is included in both the first target object assumption information and the second target object assumption information.

According to various embodiments, the one or more objects is recognized from the captured one or more images by using artificial intelligence and the speaker is recognized from the recognized one or more objects by using artificial intelligence.

According to various embodiments, recognizing the speaker from among the recognized one or more objects may comprise acquiring position information of the speaker when the speech is acquired through the microphone and determining whether a person is detected in an area in which the speaker is expected to be present within the captured one or more images based on the acquired position information of the speaker; wherein the speaker is recognized by determining that lips of the detected person in the area are moving when the detected person is present within the captured one or more images.

According to various embodiments, the method may further comprise obtaining third target object assumption information from an external device, and wherein the target objects are determined based at least in part on the first target object assumption information, the second target object assumption information, and the third target object assumption information.

According to various embodiments, a method may comprise capturing one or more images by a camera, acquiring speech through a microphone, transmitting the acquired speech to an external speech-to-text (STT) server via a communication unit capable of communicating with external devices, obtaining, from the STT server, text data from the acquired speech, transmitting the obtained text data to an external natural language processing (NLP) server via the communication unit, obtaining, from the NLP server, a pronoun list and a first target object assumption information from the text data, wherein the first target object assumption information includes target objects assumed to be referred to by respective pronouns in the pronoun list based on contextual information from the obtained text data, recognizing one or more objects from the one or more images captured by the camera, recognizing a speaker from among the recognized one or more objects, generating second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition, determining target objects referred to by the pronouns and determining target object names corresponding to the determined target objects based on the obtained first target object assumption information and the generated second target object assumption information.

As described above, the apparatus and the method according to various embodiments of the present disclosure replace a pronoun included in uttered speech with a corresponding object name. Therefore, when listening speech record later, the listeners can avoid confusion attributable to the use of pronouns during the speech. When replacing pronouns with the corresponding object names, image information is additionally used to determine the objects indicated by the respective pronouns in the voice data. Therefore, it is possible to increase the accuracy compared to an apparatus for or a method of determining objects indicated by respective pronouns using only the context information.

A method according to various embodiments of the present disclosure described above may be embodied as computer-readable codes recorded on a computer-readable medium in which a program can be recorded. The computer-readable media include all kinds of recording devices in which data that can be read by a computer system can be stored. The computer-readable media include hard disk drives (HDDs), solid state drives (SSDs), silicon disk drives (SDDs), ROMs, RAMs, CD-ROMs, magnetic tapes, floppy disks, optical data storage devices, and the like.

What is claimed is:

1. An electronic device comprising:
at least one camera configured to capture one or more images;
a microphone configured to acquire speech; and
at least one processor configured to:
acquire the speech through the microphone;
generate text data from the acquired speech;
generate a pronoun list and first target object assumption information from the generated text data, wherein the first target object assumption information includes target objects assumed to be referred to by respective pronouns in the pronoun list based on contextual information from the generated text data;
recognize one or more objects from the one or more images captured by the at least one camera;
recognize a speaker from among the recognized one or more objects;
generate second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition;
determine target objects referred to by the respective pronouns; and
determine target object names corresponding to the determined target objects based on the generated first target object assumption information and the generated second target object assumption information.

2. The electronic device of claim 1, wherein the at least one processor is further configured to replace audio portions including pronouns in the acquired speech with corresponding generated voice representations of the determined target object names or replace textual portions including the pronouns from the generated text data with corresponding text representations of the determined target object names.

3. The electronic device of claim 1, wherein the at least one processor is further configured to associate at least one of an object image, a memo, or a hypertext representing a determined target object name to a corresponding pronoun in the generated text data.

4. The electronic device of claim 1, wherein the at least one processor is further configured to:
analyze a context of a sentence associated with each pronoun in the pronoun list;
generate a target object list based on the generated second target object assumption information, wherein the target object list includes particular objects assumed to be indicated by the respective pronouns in the pronoun list; and
generate confidence values for the particular target objects in the target object list based on a result of the analysis.

5. The electronic device of claim 1, wherein generating the second target object assumption information comprises:
detecting the gaze of the recognized speaker by tracking facial orientation and pupils of the recognized speaker from the one or more captured images;
determining a first position corresponding to a target of the gaze of the recognized speaker or a second position indicated by the recognized speaker; and
setting an area of a predetermined size in a vicinity of at least one of the first position or the second position, wherein the second target object assumption information is generated based on recognizing particular objects in the set area.

6. The electronic device of claim 1, further comprising:
a plurality of cameras each facing different orientations;
wherein the one or more processors are further configured to recognize the one or more objects by:
detecting the gaze of the recognized speaker by tracking facial orientation and pupils of the recognized speaker in a first image in which the recognized speaker is included from among the one or more images captured by the plurality of cameras;
determining a first position corresponding to a target of the gaze of the recognized speaker or a second position indicated by the recognized speaker;
recognizing a second image including at least one of the first position or the second position from among the captured one or more images based at least in part on the orientation of each of the plurality of cameras; and
setting an area of a predetermined size in a vicinity of at least one of the first position or the second in the second image, wherein the second target object assumption information is generated based on recognizing particular objects in the set area.

7. The electronic device of claim 1, wherein the at least one processor is further configured to determine that a specific target object from among the determined target objects as an object indicated by a corresponding one of the pronouns in the pronoun list when the specific target object is included in both the first target object assumption information and the second target object assumption information.

8. The electronic device of claim 1, wherein the one or more objects is recognized from the captured one or more images by using artificial intelligence and the speaker is recognized from the recognized one or more objects by using artificial intelligence.

9. The electronic device of claim 1, wherein recognizing the speaker from among the recognized one or more objects comprises:
acquiring position information of the speaker when the speech is acquired through the microphone and
determining whether a person is detected in an area in which the speaker is expected to be present within the captured one or more images based on the acquired position information of the speaker; wherein the speaker is recognized by determining that lips of the detected person in the area are moving when the detected person is present within the captured one or more images.

10. The electronic device of claim 1, wherein the at least one processor is further configured to obtain third target object assumption information from an external device, and wherein the target objects are determined based at least in part on the first target object assumption information, the second target object assumption information, and the third target object assumption information.

11. A method, the method comprising:
acquiring speech through a microphone;
generating text data from the acquired speech;
generating a pronoun list and first target object assumption information from the generated text data, wherein the first target object assumption information includes target objects assumed to be referred to by respective pronouns in the pronoun list based on contextual information from the generated text data;
recognizing one or more objects from one or more images captured by at least one camera;
recognizing a speaker from among the recognized one or more objects;
generating second target object assumption information based at least in part on a gaze of the recognized speaker or a behavior of the recognized speaker, wherein the second target object assumption information includes information on the recognized one or more objects assumed to be indicated by the respective pronouns in the pronoun list based on image recognition;
determining target objects referred to by the respective pronouns; and
determining target object names corresponding to the determined target objects based on the generated first target object assumption information and the generated second target object assumption information.

12. The method of claim 11, further comprising: replacing audio portions including pronouns in the acquired speech with corresponding generated voice representations of the determined target object names or replacing textual portions including the pronouns from the generated text data with corresponding text representations of the determined target object names.

13. The method of claim 11, further comprising associating at least one of an object image, a memo, or a hypertext representing a determined target object name to a corresponding pronoun in the generated text data.

14. The method of claim 11, further comprising:
analyzing a context of a sentence associated with each pronoun in the pronoun list;
generating a target object list based on the generated second target object assumption information, wherein the target object list includes particular objects assumed to be indicated by the respective pronouns in the pronoun list; and
generating confidence values for the particular target objects in the target object list based on a result of the analysis.

15. The method of claim 11, wherein the generating the second target object assumption information comprises:
detecting the gaze of the recognized speaker by tracking facial orientation and pupils of the recognized speaker from the one or more captured images;
determining a first position corresponding to a target of the gaze of the recognized speaker or a second position indicated by the recognized speaker; and
setting an area of a predetermined size in a vicinity of at least one of the first position or the second position, wherein the second target object assumption information is generated based on recognizing particular objects in the set area.

16. The method of claim 11, wherein the one or more objects are recognized by:
detecting the gaze of the recognized speaker by tracking facial orientation and pupils of the recognized speaker in a first image in which the recognized speaker is included from among one or more images captured by a plurality of cameras, wherein the plurality of cameras each face different orientations;
determining a first position corresponding to a target of the gaze of the recognized speaker or a second position indicated by the recognized speaker;
recognizing a second image including at least one of the first position or the second position from among the captured one or more images based at least in part on the orientation of each of the plurality of cameras; and
setting an area of a predetermined size in a vicinity of at least one of the first position or the second in the second image, wherein the second target object assumption information is generated based on recognizing particular objects in the set area.

17. The method of claim 11, further comprising determining that a specific target object from among the determined target objects as an object indicated by a corresponding one of the pronouns in the pronoun list when the specific target object is included in both the first target object assumption information and the second target object assumption information.

18. The method of claim 11, wherein the one or more objects is recognized from the captured one or more images by using artificial intelligence and the speaker is recognized from the recognized one or more objects by using artificial intelligence.

19. The method of claim 11, wherein recognizing the speaker from among the recognized one or more objects comprises:
acquiring position information of the speaker when the speech is acquired through the microphone and
determining whether a person is detected in an area in which the speaker is expected to be present within the captured one or more images based on the acquired position information of the speaker; wherein the speaker is recognized by determining that lips of the detected person in the area are moving when the detected person is present within the captured one or more images.

20. The method of claim 11, further comprising obtaining third target object assumption information from an external device, and wherein the target objects are determined based at least in part on the first target object assumption information, the second target object assumption information, and the third target object assumption information.
